(19) United States
(12) Patent Application Publication
(10) Pub. No.: US 2007/0207029 A1
(43) Pub. Date: Sep. 6, 2007

(54) Fluid force taking-up and boosting apparatus

(76) Inventor: Tatuya Mikami, Ichikawa-shi (JP)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/714,189

(22) Filed: Mar. 6, 2007

(30) Foreign Application Priority Data
Mar. 6, 2006 (JP) 2006-110235

(51) Int. Cl. F03B 15/06

(52) U.S. Cl. 415/4.1

(57) ABSTRACT

A fluid force taking-up and boosting apparatus is provided with a tubular member, an inner space of which is partitioned by a bulkhead into two channels elongating in a longitudinal direction. One channel allows a flow of fluid from one end portion toward the other end portion in the longitudinal direction, and the other channel allows a flow of fluid from the other end portion to the one end portion in the longitudinal direction. Two fluid receiving wheels are supported rotatably at two positions spaced from one another in the longitudinal direction in the bulkhead, and rotate in the same direction by the fluids flowing in the two channels. A winding/interlocking member is wound around the two wheels and interlocks the wheels, and a rotation force from the two wheels is transmitted to an output shaft. The other end portion of the other channel may be closed at least partially.

### CROSS-REFERENCE TO RELATED APPLICATIONS

This application is based upon and claims the benefit of priority from prior Japanese Patent Application No. 2006-110235, filed Mar. 6, 2006, the entire contents of which are incorporated herein by reference.

### BACKGROUND OF THE INVENTION

1. Field of the Invention

The invention relates to an apparatus which takes up and boosts a fluid force.

2. Description of the Related Art

A fluid force taking-up and boosting apparatus has been known in, for example, Jpn. Pat. Appln. KOKAI Publication No. 2006-9775.

In recent years, from the standpoint of environmental issues and energy problems, it has been strongly desired to take up fluid force of a fluid such as wind or running water in nature and to use the fluid force more effectively than by a conventional art.

An object of this invention is to provide a fluid force taking-up and boosting apparatus in which it is possible to take up fluid force of a fluid such as wind or running water in nature and to use the fluid force more effectively than by the conventional art.

### BRIEF SUMMARY OF THE INVENTION

According to one aspect of this invention, a fluid force taking-up and boosting apparatus comprises: a tubular member which includes both end portions in a longitudinal direction, an inner space having through openings provided at the both end portions and communicated with an outer space through the openings, and a main bulkhead elongated in the inner space in the longitudinal direction and partitioning the inner space into two main flow channels elongating in the longitudinal direction, wherein one of the two main flow channels is configured to allow a flow of fluid from the one end portion toward the other end portion in the longitudinal direction, and the other of the two main flow channels is configured to allow a flow of fluid from the other end portion to the one end portion in the longitudinal direction; two fluid receiving wheels which are supported rotatably at two positions spaced from one another in the longitudinal direction in the main bulkhead, and which rotate in the same direction by the fluids flowing in the two main flow channels at both sides of the main bulkhead; a winding/interlocking member which is wound around the two fluid receiving wheels and interlocks the two fluid receiving wheels; and an output shaft to which a rotation force from the two fluid receiving wheels is transmitted.

According to another aspect of this invention, a fluid force taking-up and boosting apparatus comprises: a tubular member which includes both end portions in a longitudinal direction, an inner space having through openings provided at the both end portions and communicated with an outer space through the openings, and a main bulkhead elongated in the inner space in the longitudinal direction and partitioning the inner space into two main flow channels elongating in the longitudinal direction, wherein one of the two main flow channels is configured to allow a flow of fluid from the one end portion to the other end portion in the longitudinal direction, and the other of the two main flow channels is closed at the other end portion at least partially in the longitudinal direction by a baffle plate and is configured to allow a flow of fluid from the other end portion to the one end portion in the longitudinal direction; two fluid receiving wheels which are supported rotatably at two positions spaced from one another in the longitudinal direction in the main bulkhead, and which rotate in the same direction by the fluids flowing in the two main flow channels at both sides of the main bulkhead; a winding/interlocking member which is wound around the two fluid receiving wheels and interlocks the two fluid receiving wheels; a communicating channel which is provided at a position closer to one end of the tubular member from the fluid receiving wheel close to the one end of the tubular member in the main bulkhead and allows a flow of fluid from the other main flow channel to the one main flow channel; and an output shaft to which a rotation force from the two fluid receiving wheels is transmitted.

Additional objects and advantages of the invention will be set forth in the description which follows, and in part will be obvious from the description, or may be learned by practice of the invention. The objects and advantages of the invention may be realized and obtained by means of the instrumentalities and combinations partially pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic horizontal sectional view of a fluid force taking-up and boosting apparatus according to a first embodiment of the invention;

FIG. 2 is a schematic vertical and longitudinal sectional view taken along a line II-II in FIG. 1;

FIG. 3 is a schematic enlarged horizontal sectional view of a sub-flow channel fluid compression/supply device used in the fluid force taking-up and boosting apparatus of FIG. 1;

FIG. 4 is a schematic enlarged horizontal sectional view of an outer fluid compression/supply device along with a sub-flow channel fluid compression/supply device used in the fluid force taking-up and boosting apparatus of FIG. 1;

FIG. 5 is a schematic horizontal sectional view of a fluid force taking-up and boosting apparatus according to a second embodiment of this invention;

FIG. 6 is a schematic vertical and cross sectional view when two of the fluid force taking-up and boosting apparatuses are combined with each other, each apparatus according to the first embodiment of FIG. 1 or according to the second embodiment of FIG. 2;

FIG. 7 is a schematic cross sectional view of a flow channel fluid compression device; and

FIG. 8 is a schematic cross sectional view of the fluid force taking-up and boosting apparatus according to the second embodiment of this invention and combined with a flow channel along with a flow channel fluid compression device other than that of FIG. 7.

### DETAILED DESCRIPTION OF THE INVENTION

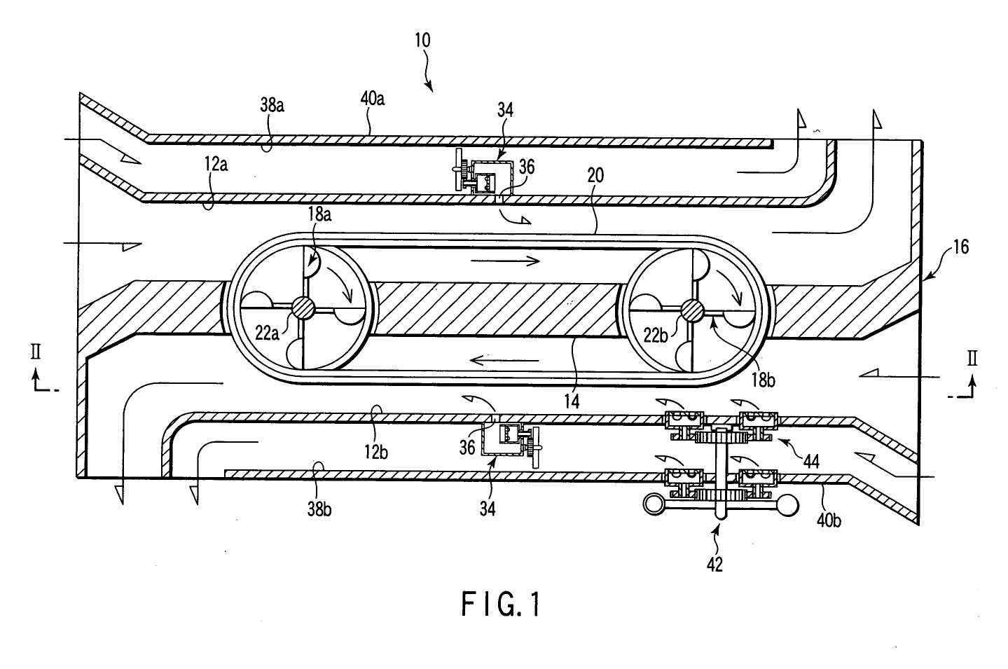

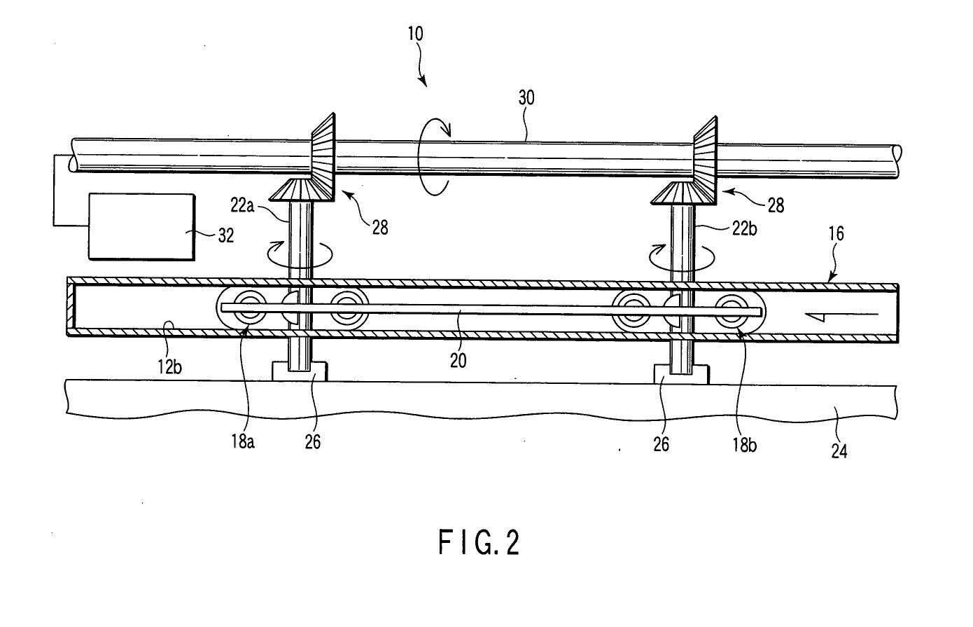

First, a fluid force taking-up and boosting apparatus 10 according to a first embodiment of the invention will be described with reference to FIGS. 1 and 2.

The fluid force taking-up and boosting apparatus 10 comprises a tubular member 16 including both end portions in its longitudinal direction.

An inner space of the tubular member 16 has through openings provided at the both end portions and is communicated with an outer space through the openings. The inner space is partitioned by a main bulkhead 14 elongating in the longitudinal direction into two main flow channels 12a and 12b elongating in the longitudinal direction in the inner space.

The one main flow cannel 12a is configured to allow a flow of fluid from the one end portion to the other end portion in the longitudinal direction, and the other main flow cannel 12b is configured to allow a flow of fluid from the other end portion to the one end portion in the longitudinal direction.

More specifically, the one main flow channel 12a elongates along the longitudinal direction in the tubular member 16, and the opening of the one main flow channel 12a at the one end portion (the left end portion in FIG. 1) in the longitudinal direction of the tubular member 16 faces in the longitudinal direction. The opening of the one main flow channel 12a at the other end portion (the right end portion in FIG. 1) in the longitudinal direction of the tubular member 16 faces in a lateral direction of the other end portion.

Also, the other main flow channel 12b elongates along the longitudinal direction in the tubular member 16. However, in contrast to the one main flow channel 12a, the opening of the other main flow channel 12b at one end portion (the left end portion in FIG. 1) in the longitudinal direction of the tubular member 16 faces in a lateral direction of the one end portion, and the opening of the other main flow channel 12b at the other end portion (the right end portion in FIG. 1) in the longitudinal direction of the tubular member 16 faces in the longitudinal direction.

Two fluid receiving wheels 18a and 18b are supported rotatably at two positions spaced from one another in the longitudinal direction in the main bulkhead 14. Fluids flowing in the two main flow channels 12a and 12b at the both sides of the main bulkhead 14 strikes the two fluid receiving wheels 18a and 18b and rotates the fluid receiving wheels 18a and 18b.

A winding/interlocking member 20 for interlocking the two fluid receiving wheels 18a and 18b is wound around the outer circumferential surfaces of the two fluid receiving wheels 18a and 18b. The winding/interlocking member 20 is, for example, a so-called power transmission belt. The winding/interlocking member 20 rotates the two fluid receiving wheels 18a and 18b in the same direction by the fluids flowing in the two main flow channels 12a and 12b at the both sides of the main bulkhead 14.

A fluid flowing from the one end portion (the left end portion in FIG. 1) in the longitudinal direction of the tubular member 16 toward the other end portion (the right end portion in FIG. 1) in the longitudinal direction of the tubular member 16 in the outer side of the tubular member 16, is introduced into the one main flow channel 12a of the tubular member 16 from the opening of the one main flow channel 12a facing in the longitudinal direction at the one end portion (the left end portion in FIG. 1) in the longitudinal direction of the tubular member 16. The introduced outer fluid strikes the two fluid receiving wheels 18a and 18b in the one main flow channel 12a and rotates the two fluid receiving wheels 18a and 18b in the same direction (clockwise in FIG. 1). During this time, the above-described fluid is not introduced into the other main flow channel 12b of the tubular member 16 from the opening of the other main flow channel 12b facing in the lateral direction at the one end portion (the left end portion in FIG. 1) in the longitudinal direction of the tubular member 16.

In contrast thereto, a fluid flowing from the other end portion (the right end portion in FIG. 1) in the longitudinal direction of the tubular member 16 toward the one end portion (the left end portion in FIG. 1) in the longitudinal direction of the tubular member 16 in the outer side of the tubular member 16, is introduced into the other main flow channel 12b of the tubular member 16 from the opening of the other main flow channel 12b facing in the longitudinal direction at the other end portion (the right end portion in FIG. 1) in the longitudinal direction of the tubular member 16. The introduced outer fluid strikes the two fluid receiving wheels 18a and 18b in the other main flow channel 12b and rotates the two fluid receiving wheels 18a and 18b in the same direction (clockwise in FIG. 1). During this time, the above-described fluid is not introduced into the one main flow channel 12a of the tubular member 16 from the opening of the one main flow channel 12a facing in the lateral direction at the other end portion (the right end portion in FIG. 1) in the longitudinal direction of the tubular member 16.

Both end portions of each of rotation center shafts 22a and 22b of the two fluid receiving wheels 18a and 18b project into the outer side of the tubular member 16. One end portion is supported on a base 24 by a bearing 26, and the other end portion is connected to a common output shaft 30 via a well-known power transmission mechanism (a pair of bevel gears meshing with one another in this embodiment) 28. The power transmission mechanisms 28 at the other end portions of the rotation center shafts 22a and 22b of the two fluid receiving wheels 18a and 18b transmit rotation forces from the two fluid receiving wheels 18a and 18b to the common output shaft 30. The output shaft 30 can supply a driving force to an external device 32 such as an electric generator.

An outer fluid compression/supply device 34 is provided on the peripheral wall of the tubular member 16 to correspond to at least one of the two main flow channels 12a and 12b, but to correspond to each of the two main flow channels 12a and 12b in the present embodiment. The outer fluid compression/supply device 34 is communicated with the corresponding main flow channel 12a or 12b via a through-hole 36 formed in the peripheral wall of the tubular member 16.

The outer fluid compression/supply device 34 is rotated by a fluid force of a fluid flowing in the longitudinal direction along the peripheral wall of the tubular member 16 in the outer side of the tubular member 16 to compress the fluid flowing in the outer side of the tubular member 16 and to supply the compressed outer fluid into the corresponding main flow channel 12a or 12b via the through-hole 36.

The outer fluid compression/supply device 34 accelerates the fluid flowing in the corresponding main flow channel 12a or 12b by supplying the compressed outer fluid into the corresponding main flow channel 12a or 12b via the through-hole 36. As a result, it is possible to increase the rotation force transmitted to the output shaft 30 from the two fluid receiving wheels 18a and 18b rotated by the fluid flowing in the corresponding main flow channel 12a or 12b.

The fluid force taking-up and boosting apparatus 10 according to the first embodiment further has two sub-flow channel members 40a and 40b provided to correspond to the two main flow channels 12a and 12b at the outer circumferential surface of the tubular member 16 and including two sub-flow channels 38a and 38b elongating along the two main flow channels 12a and 12b.

The one sub-flow channel 38a corresponding to the one main flow channel 12a is configured to allow a flow of fluid from the one end portion to the other end portion in the longitudinal direction in the same way as the one main flow channel 12a, and the other sub-flow channel 38b corresponding to the other main flow channel 12b is configured to allow a flow of fluid from the other end portion to one end portion in the longitudinal direction in the same way as the other main flow channel 12b.

More particularly, the two sub-flow channels 38a and 38b in the two sub-flow channel members 40a and 40b are configured in the same way as the corresponding two main flow channels 12a and 12b. Namely, the one sub-flow channel 38a elongates along the longitudinal direction in the one sub-flow channel member 40a, the opening of the one sub-flow channel 38a at the one end portion (the left end portion in FIG. 1) in the longitudinal direction of the one sub-flow channel member 40a faces in the longitudinal direction, and the opening of the one sub-flow channel 38a at the other end portion (the right end portion in FIG. 1) in the longitudinal direction of the one sub-flow channel member 40a faces in the lateral direction of the other end portion.

Also, the other sub-flow channel 38b elongates along the longitudinal direction in the other sub-flow channel member 40b. However, in contrast to the one sub-flow channel 38a, the opening of the other sub-flow channel 38b at the one end portion (the left end portion in FIG. 1) in the longitudinal direction of the other sub-flow channel member 40b faces in the lateral direction of the one end portion, and the opening of the other sub-flow channel 38b at the other end portion (the right end portion in FIG. 1) in the longitudinal direction of the other sub-flow channel member 40b faces in the longitudinal direction.

A fluid flowing from the one end portion (the left end portion in FIG. 1) in the longitudinal direction of the tubular member 16 toward the other end portion (the right end portion in FIG. 1) in the longitudinal direction of the tubular member 16 in the outer side of the tubular member 16, is introduced into the one sub-flow channel 38a of the one sub-flow channel member 40a from the opening of the one sub-flow channel 38a facing in the longitudinal direction at the one end portion (the left end portion in FIG. 1) in the longitudinal direction of the one sub-flow channel member 40a. During this time, the above-described fluid is not introduced into the other sub-flow channel 38b of the other sub-flow channel member 40b from the opening of the other sub-flow channel 38b facing in the lateral direction at the one end portion (the left end portion in FIG. 1) in the longitudinal direction of the other sub-flow channel member 40b.

In contrast thereto, a fluid flowing from the other end portion (the right end portion in FIG. 1) in the longitudinal direction of the tubular member 16 toward the one end portion (the left end portion in FIG. 1) in the longitudinal direction of the tubular member 16 in the outer side of the tubular member 16, is introduced into the other sub-flow channel 38b of the other sub-flow channel member 40b from the opening of the other sub-flow channel 38b facing in the longitudinal direction at the other end portion (the right end portion in FIG. 1) in the longitudinal direction of the other sub-flow channel member 40b. The above-described fluid is not introduced into the one sub-flow channel 38a of the one sub-flow channel member 40a from the opening of the one sub-flow channel 38a facing in the lateral direction at the other end portion (the right end portion in FIG. 1) in the longitudinal direction of the one sub-flow channel member 40a.

The outer fluid compression/supply device 34 provided on the peripheral wall of the tubular member 16 to correspond to at least one of the two main flow channels 12a and 12b, but to each of the both of the two main flow channels 12a and 12b in the present embodiment, is housed in each of the two sub-flow channels 38a and 38b of the two sub-flow channel members 40a and 40b and provides a sub-flow channel fluid compression/supply device which is rotated by a fluid force of the fluid flowing in each of the sub-flow channels 38a and 38b to compress the fluid flowing in each of the sub-flow channels 38a and 38b and to supply the compressed fluid into each of the corresponding main flow channels 12a and 12b.

The fluid force taking-up and boosting apparatus 10 according to the first embodiment further has another outer fluid compression/supply device 42 which is provided to correspond to at least one of the peripheral walls of the two sub-flow channel members 40a and 40b, but preferably to each of the both peripheral walls of the two sub-flow channel members 40a and 40b.

The outer fluid compression/supply device 42 is rotated by a fluid force of a fluid flowing in the outer side of the at least one of the two sub-flow channel members 40a and 40b, but preferably in the outer side of each of the two sub-flow channel members 40a and 40b, compresses the fluid flowing in the outer side portion of the sub-flow channel member 40a or 40b, and supplies the compressed outer fluid into the sub-flow channel 38a or 38b of the at least one of both corresponding sub-flow channel members 40a and 40b, but preferably into the sub-flow channels 38a and 38b of the both corresponding sub-flow channel members 40a and 40b.

The outer fluid compression/supply device 42 accelerates the fluid flowing in the corresponding sub-flow channel 38a or 38b by supplying the compressed outer fluid into the corresponding sub-flow channel 38a or 38b. As a result, it is possible to further improve a pressure of the pressurized fluid which is compressed in the sub-flow channel 38a or 38b by the above-described outer fluid compression/supply device 34 as the sub-flow channel fluid compression/supply device housed in the corresponding sub-flow channel 38a or 38b and which is supplied to the corresponding main flow channel 12a or 12b. Consequently, it is possible to increase the rotation force transmitted to the common output shaft 30 from the two fluid receiving wheels 18a and 18b rotated by the fluid flowing in the corresponding main flow channel 12a or 12b.

The other outer fluid compression/supply device 42 which is provided to correspond to at least one of the peripheral walls of the two sub-flow channel members 40a and 40b, but preferably to each of the both peripheral walls of the two sub-flow channel members 40a and 40b, further has a sub-flow channel fluid compression/supply device 44 which is provided in the sub-flow channel 38a or 38b of at least one of the corresponding sub-flow channel members 40a and 40b, but preferably each of the both corresponding sub-flow channel members 40a and 40b. The sub-flow channel fluid compression/supply device 44 is rotated by a rotation force from the outer fluid compression/supply device 42, compresses the fluid flowing in at least one of the corresponding sub-flow channels 38a and 38b, but preferably in each of both corresponding sub-flow channels 38a and 38b and supplies the compressed fluid into the corresponding main flow channel 12a or 12b.

In the same way as in the outer fluid compression/supply device 34 configuring the sub-flow channel fluid compression/supply device as described above, the additional sub-flow channel fluid compression/supply device 44 compresses and pressurizes the fluid flowing in at least one of the corresponding sub-flow channels 38a and 38b, but preferably in each of both corresponding sub-flow channels 38a and 38b, and thereafter, supplies the pressurized fluid into the corresponding main flow channel 12a or 12b to accelerate the fluid flowing in the corresponding main flow channel 12a or 12b. As a result, it is possible to increase the rotation force transmitted to the common output shaft 30 from the two fluid receiving wheels 18a and 18b rotated by the fluid flowing in the corresponding main flow channel 12a or 12b.

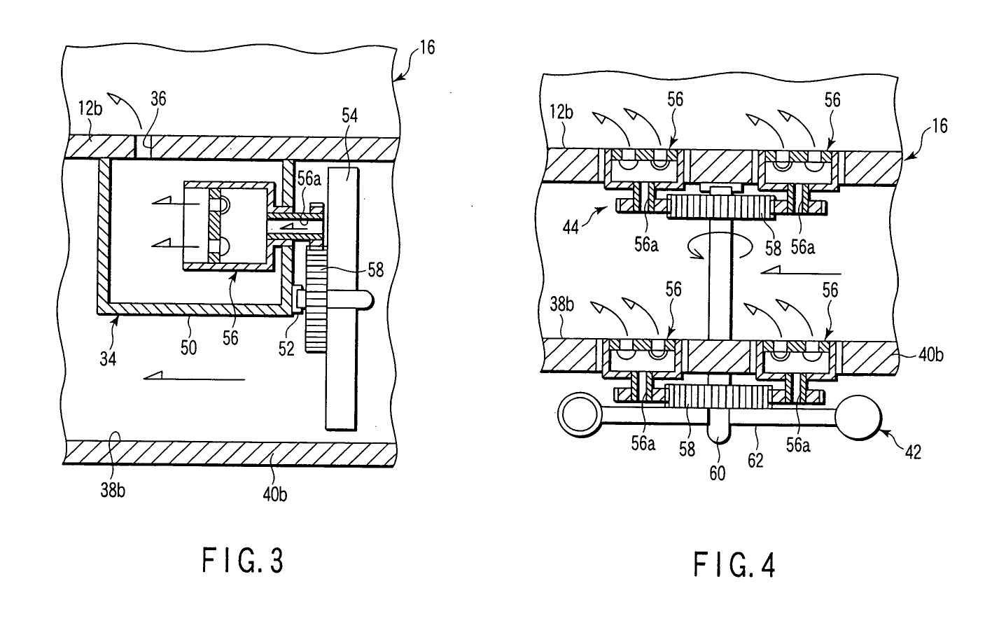

Next, the structure of the outer fluid compression/supply device 34 which is housed in the sub-flow channel 38b and configures the sub-flow channel fluid compression/supply device will be described with reference to FIG. 3.

The outer fluid compression/supply device (the sub-flow channel fluid compression/supply device) 34 includes a housing 50 covering the through-hole 36 formed to correspond to the sub-flow channel 38b in the outer circumferential surface of the tubular member 16. The outer shape of the housing 50 is preferably a streamline shape in order to reduce a resistance against the flow of fluid flowing in the sub-flow channel 38b as much as possible. A fluid receiving rotation member 54 such as a propeller is supported rotatably by a bearing 52 at a portion facing the upstream of the flow of the fluid flowing in the sub-flow channel 38b on the housing 50. The fluid receiving rotation member 54 is rotated in a predetermined direction by the flow of the fluid flowing in the sub-flow channel 38b.

A well-known fluid compression mechanism 56 is disposed in the inner space of the housing 50. The compression mechanism 56 has a fluid suction pipe 56a which is projected at the above-described portion of the housing 50 and which is supported rotatably at the above-described portion. A rotation force is transmitted to the projected end portion of the fluid suction pipe 56a from the fluid receiving rotation member 54 by a well-known rotational force transmission mechanism 58 such as a spur gear train. The fluid flowing in the sub-flow channel 38b is introduced into the fluid compression mechanism 56 through the opening of the projected end of the fluid suction pipe 56a. The fluid compression mechanism 56 is driven by the rotation force transmitted from the fluid receiving rotation member 54 via the rotation force transmission mechanism 58 and the fluid suction pipe 56a, compresses the above-described fluid introduced from the fluid suction pipe 56a, and discharges the compressed fluid into the inner space of the housing 50. The pressurized fluid in the inner space flows into the corresponding main flow channel 12b through the through-hole 36 in the outer circumferential surface of the tubular member 16. The through-hole 36 is preferably inclined toward the direction of the flow of the fluid in the corresponding sub-flow channel 38b.

Next, the structure of the additional outer fluid compression/supply device 42 having the sub-flow channel fluid compression/supply device 44, which is provided in the sub-flow channel member 40b, will be described with reference to FIG. 4.

The outer fluid compression/supply device 42 has a rotation center shaft 60 which extends from the outside of the circumferential wall of the sub-flow channel member 40b to the portion of the circumferential wall of the tubular member 16 corresponding to the circumferential wall of the sub-flow channel member 40b in a direction crossing the longitudinal center line of the tubular member 16, and the rotation center shaft 60 is rotatably supported by the circumferential walls of the sub-flow channel member 40b and tubular member 16.

A fluid receiving rotation member 62 is fixed to the outer end portion of the rotation center shaft 60, and the fluid receiving rotation member 62 receives by the fluid flowing along the longitudinal center line of the tubular member 16 in the out side of the tubular member 16.

A plurality of fluid compression mechanisms 56 are arranged around the rotation center shaft 60 in the circumferential wall of the sub-flow channel member 40b. The fluid suction pipe 56a of each fluid compression mechanism 56 project out from the circumferential wall of the sub-flow channel member 40b. A rotation force is transmitted to the projected end portion of the fluid suction pipe 56a from the fluid receiving rotation member 62 with the well-known rotation force transmission mechanism 58 such as for example a spur gear train. The fluid flowing on the circumferential wall of the tubular member 16 is introduced into the fluid compression mechanism 56 through the opening of the projected end of the fluid suction pipe 56a. The fluid compression mechanism 56 is driven by the rotational force transmitted from the fluid receiving rotation member 62 through the rotation force transmission mechanism 58 and the fluid suction pipe 56a, compresses the fluid introduced from the fluid suction pipe 56a, and supplies the pressurized fluid into the sub-flow channel 38b. It is preferable that the fluid compression mechanism 56 supplies the pressurized fluid into the sub-flow channel 38b in a direction inclined toward the direction of the flow of the fluid in the corresponding sub-flow channel 38b.

A plurality of fluid compression mechanisms 56 are arranged around the rotation center shaft 60 in the circumferential wall of the tubular member 16. The fluid suction pipe 56a of each fluid compression mechanism 56 project out from the circumferential wall of the tubular member 16. A rotation force is transmitted to the projected end portion of the fluid suction pipe 56a from the fluid receiving rotation member 62 with the rotation center shaft 60 and the well-known rotation force transmission mechanism 58 such as for example a spur gear train. The fluid flowing on circumferential wall of the tubular member 16 is introduced into the fluid compression mechanism 56 through the opening of the projected end of the fluid suction pipe 56a. The fluid compression mechanism 56 is driven by the rotational force transmitted from the fluid receiving rotation member 62 through the rotation center shaft 60, the rotation force transmission mechanism 58, and the fluid suction pipe 56a, compresses the fluid introduced from the fluid suction pipe 56a, and supplies the pressurized fluid into the main flow channel 12b. It is preferable that the fluid compression mechanism 56 supplies the pressurized fluid into the main flow channel 18b in a direction inclined toward the direction of the flow of the fluid in the corresponding main flow channel 38b.

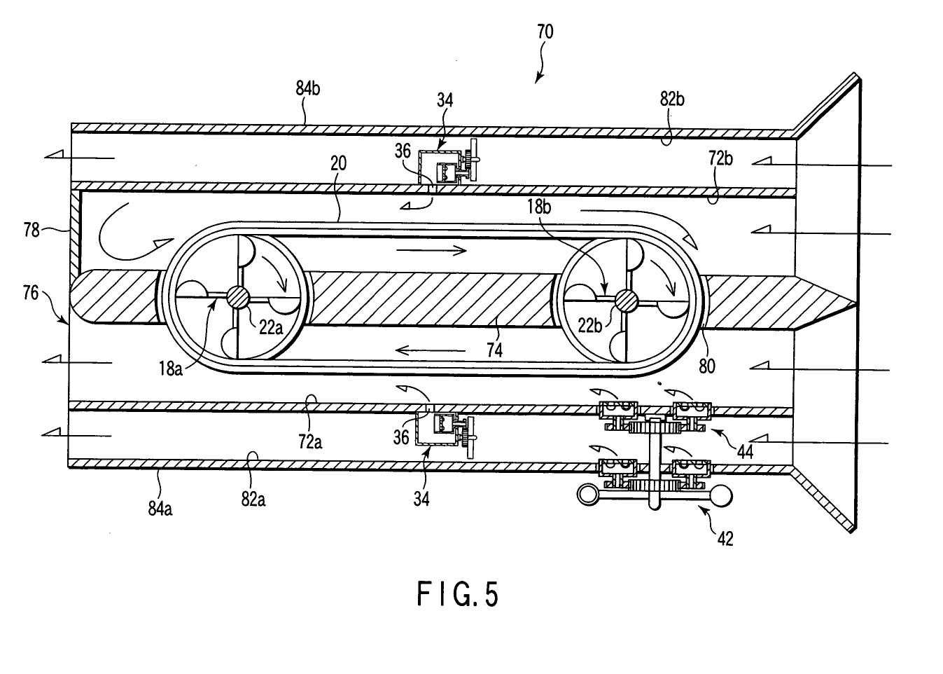

Next, a fluid force taking-up and boosting apparatus 70 according to a second embodiment of the invention will be described with reference to FIG. 5.

The fluid force taking-up and boosting apparatus 70, like the fluid force taking-up and boosting apparatus 10 according to the first embodiment, comprises a tubular member 76 including both end portions in its longitudinal direction. An inner space of the tubular member 76 has through openings provided at the both end portions and is communicated with an outer space through the openings. The inner space is partitioned by a main bulkhead 74 elongating in the longitudinal direction into two main flow channels 72a and 72b elongating in the longitudinal direction in the inner space.

The fluid force taking-up and boosting apparatus 70 of this embodiment is different from the fluid force taking-up and boosting apparatus 10 according to the first embodiment in that the one main flow cannel 72a is configured to allow a flow of fluid from the one end portion (the right end portion in FIG. 5) to the other end portion (the left end portion in FIG. 5) in the longitudinal direction, but the other end portion (the left end portion in FIG. 5) of the other main flow cannel 72b in the longitudinal direction is configured to allow a flow of fluid from one end portion (the right end portion in FIG. 5) to the other end portion (the left end portion in FIG. 5) in the longitudinal direction while at least a part of the other end portion (the left end portion in FIG. 5) of the other main flow cannel 72b in the longitudinal direction is closed by a baffle plate 78.

More specifically, the one main flow channel 72a elongates along the longitudinal direction in the tubular member 76, and the opening of the one main flow channel 72a at the one end portion (the right end portion in FIG. 5) in the longitudinal direction of the tubular member 16 faces in the longitudinal direction. The opening of the one main flow channel 72a at the other end portion (the left end portion in FIG. 5) in the longitudinal direction of the tubular member 76 faces in the longitudinal direction.

Also, the other main flow channel 72b elongates along the longitudinal direction in the tubular member 76. However, in contrast to the one main flow channel 72a, the opening of the other main flow channel 72b at the one end portion (the right end portion in FIG. 5) in the longitudinal direction of the tubular member 76 faces in the longitudinal direction, and at least a part of the opening of the other main flow channel 72b at the other end portion (the left end portion in FIG. 5) in the longitudinal direction of the tubular member 16 is closed the baffle plate 78.

As in the main bulkhead 14 of the tubular member 16 of the fluid force taking-up and boosting apparatus 10 according to the first embodiment, two fluid receiving wheels 18a and 18b are supported rotatably at two positions spaced from one another in the longitudinal direction in the main bulkhead 74. Fluids flowing in the two main flow channels 72a and 72b at the both sides of the main bulkhead 74 strikes the two fluid receiving wheels 18a and 18b and rotates the fluid receiving wheels 18a and 18b.

A winding/interlocking member 20 for interlocking the two fluid receiving wheels 18a and 18b is wound around the outer circumferential surfaces of the two fluid receiving wheels 18a and 18b.

A fluid flowing from the one end portion (the right end portion in FIG. 5) in the longitudinal direction of the tubular member 76 toward the other end portion (the left end portion in FIG. 5) in the longitudinal direction of the tubular member 76 in the outer side of the tubular member 76, is introduced into the one main flow channel 72a of the tubular member 76 from the opening of the one main flow channel 72a facing in the longitudinal direction at the one end portion (the right end portion in FIG. 5) in the longitudinal direction of the tubular member 76. The introduced outer fluid strikes the two fluid receiving wheels 18a and 18b in the one main flow channel 72a and rotates the two fluid receiving wheels 18a and 18b in the same direction (clockwise in FIG. 5).

During this time, the above-described fluid is introduced into the other main flow channel 72b of the tubular member 76 from the opening of the other main flow channel 72b facing in the longitudinal direction at the one end portion (the right end portion in FIG. 5) in the longitudinal direction of the tubular member 76. The introduced outer fluid collides with the baffle plate 78 at the other end portion (the left end portion in FIG. 5) in the longitudinal direction of the tubular member 76 in the other main flow channel 72b, and stays at the other end portion (the left end portion in FIG. 5) in the other main flow channel 72b. However, the stayed fluid is moved toward the one end portion (the right end portion in FIG. 5) in the longitudinal direction of the tubular member 76 along the main bulkhead 74 owing to the two fluid receiving wheels 18a and 18b rotating by the outer fluid introduced into the one main flow channel 72a, and flows out from the other main flow channel 72b to the one main flow channel 72a through a gap 80 positioned closer to the one end (the right end in FIG. 5) of the tubular member 76 than the fluid receiving wheel 22b near to the one end (the right end in FIG. 5) of the tubular member 76 in the main bulkhead 74. That is, in this embodiment, the gap 80 functions as a communication pass for allowing a flow of the fluid from the other main flow channel 72b to the one main flow channel 72a.

The fluid force taking-up and boosting apparatus 70 of this embodiment does not consider to use a fluid flowing from the one end portion (the right end portion in FIG. 5) in the longitudinal direction of the tubular member 76 toward the other end portion (the left end portion in FIG. 5) in the longitudinal direction of the tubular member 76 in the out side of the tubular member 76.

This means that the fluid force taking-up and boosting apparatus 70 of this embodiment is configured to be used in a condition that the one end portion (the right end portion in FIG. 5) in the longitudinal direction of the tubular member 76 is always directed toward the upstream of the fluid flowing along the circumference of the tubular member 76.

Like in the case of the fluid force taking-up and boosting apparatus 10 of the first embodiment shown in FIG. 2, the rotation forces from the two fluid receiving wheels 18a and 18b are transmitted to the common output shaft 30 through the power transmission mechanisms 28 at the other end portions of the rotation center shafts 22a and 22b of the two fluid receiving wheels 18a and 18b.

Also in this embodiment, like in the above described first embodiment, the outer fluid compression/supply device 34 is provided on the peripheral wall of the tubular member 76 to correspond to at least one of the two main flow channels 72a and 72b, but to correspond to each of the two main flow channels 72a and 72b in the present embodiment. The outer fluid compression/supply device 34 is communicated with the corresponding main flow channel 72a or 72b via the through-hole 36 formed in the peripheral wall of the tubular member 76.

The outer fluid compression/supply device 34 is rotated by a fluid force of a fluid flowing in the longitudinal direction along the peripheral wall of the tubular member 76 in the outer side of the tubular member 76 to compress the fluid flowing in the outer side of the tubular member 76 and to supply the compressed outer fluid into the corresponding main flow channel 72a or 72b via the through-hole 36.

The outer fluid compression/supply device 34 accelerates the fluid flowing in the corresponding main flow channel 72a or 72b by supplying the compressed outer fluid into the corresponding main flow channel 72a or 72b via the through-hole 36. As a result, it is possible to increase the rotation force transmitted to the output shaft 30 from the two fluid receiving wheels 18a and 18b rotated by the fluid flowing in the corresponding main flow channel 72a or 72b.

The fluid force taking-up and boosting apparatus 70 according to the second embodiment, like the fluid force taking-up and boosting apparatus 10 according to the first embodiment, further has two sub-flow channel members 84a and 84b provided to correspond to the two main flow channels 72a and 72b at the outer circumferential surface of the tubular member 76 and including two sub-flow channels 82a and 82b elongating along the two main flow channels 72a and 72b.

Each of the two sub-flow channels 82a and 82b, like each of the two main flow channels 72a and 72b, is configured to allow a flow of fluid from the one end portion (the right end portion in FIG. 5) to the other end portion (the left end portion in FIG. 5) in the longitudinal direction in the same way as the two main flow channel 72a and 72b.

More particularly, each of the two sub-flow channels 82a and 82b in the two sub-flow channel members 84a and 84b is configured in the same way as the one main flow channel 72a. Namely, each of the two sub-flow channels 82a and 82b elongates along the longitudinal direction in each of the sub-flow channel members 84a and 84b, the opening of each of the two sub-flow channels 82a and 82b at the one end portion (the right end portion in FIG. 5) in the longitudinal direction of each of the two sub-flow channel members 84a and 84b faces in the longitudinal direction, and the opening of each of the two sub-flow channels 82a and 82b at the other end portion (the left end portion in FIG. 5) in the longitudinal direction of each of the two sub-flow channel members 84a and 84b faces in the longitudinal direction.

A fluid flowing from the one end portion (the right end portion in FIG. 5) in the longitudinal direction of the tubular member 76 toward the other end portion (the left end portion in FIG. 5) in the longitudinal direction of the tubular member 76 in the outer side of the tubular member 76, is introduced into each of the two sub-flow channels 82a and 82b of the two sub-flow channel members 84a and 84b from the opening of each of the two sub-flow channels 82a and 82b facing in the longitudinal direction at the one end portion (the left end portion in FIG. 1) in the longitudinal direction of each of the two sub-flow channel members 84a and 84b.

In this embodiment, like the above described first embodiment, the outer fluid compression/supply device 34 provided on the peripheral wall of the tubular member 76 to correspond to at least one of the two main flow channels 82a and 82b, but to each of the both of the two main flow channels 82a and 82b in the present embodiment, is housed in each of the two sub-flow channels 82a and 82b of the two sub-flow channel members 84a and 84b and provides a sub-flow channel fluid compression/supply device which is rotated by a fluid force of the fluid flowing in each of the sub-flow channels 82a and 82b to compress the fluid flowing in each of the sub-flow channels 82a and 82b and to supply the compressed fluid into each of the corresponding main flow channels 72a and 72b.

The fluid force taking-up and boosting apparatus 70 according to the second embodiment, like the fluid force taking-up and boosting apparatus 10 according to the first embodiment, further has another outer fluid compression/supply device 42 which is provided to correspond to at least one of the peripheral walls of the two sub-flow channel members 84a and 84b, but preferably to each of the both peripheral walls of the two sub-flow channel members 84a and 84b.

The outer fluid compression/supply device 42 is rotated by a fluid force of a fluid flowing in the outer side of the at least one of the two sub-flow channel members 84a and 84b, but preferably in the outer side of each of the two sub-flow channel members 84a and 84b, compresses the fluid flowing in the outer side of the sub-flow channel member 84a or 84b, and supplies the compressed outer fluid into the sub-flow channel 82a or 82b of the at least one of both corresponding sub-flow channel members 84a and 84b, but preferably into the sub-flow channels 82a and 82b of the both corresponding sub-flow channel members 84a and 84b.

The outer fluid compression/supply device 42 accelerates the fluid flowing in the corresponding sub-flow channel 82a or 82b by supplying the compressed outer fluid into the corresponding sub-flow channel 82a or 82b. As a result, it is possible to further improve a pressure of the pressurized fluid which is compressed in the sub-flow channel 82a or 82b by the above-described outer fluid compression/supply device 34 as the sub-flow channel fluid compression/supply device housed in the corresponding sub-flow channel 82a or 82b and which is supplied to the corresponding main flow channel 72a or 72b. Consequently, it is possible to increase the rotation force transmitted to the common output shaft 30 from the two fluid receiving wheels 18a and 18b rotated by the fluids flowing in the corresponding main flow channel 72a and 72b.

Also in this embodiment, like in the first embodiment, the other outer fluid compression/supply device 42 which is provided to correspond to at least one of the peripheral walls of the two sub-flow channel members 84a and 84b, but preferably to each of the both peripheral walls of the two sub-flow channel members 84a and 84b, further has the sub-flow channel fluid compression/supply device 44 which is provided in the sub-flow channel 82a or 82b of at least one of the corresponding sub-flow channel members 84a and 84b, but preferably each of the both corresponding sub-flow channel members 84a and 84b. The sub-flow channel fluid compression/supply device 44 is rotated by a rotation force from the outer fluid compression/supply device 42, compresses the fluid flowing in at least one of the corresponding sub-flow channels 82a and 82b, but preferably in each of both corresponding sub-flow channels 82a and 82b and supplies the compressed fluid into the corresponding main flow channel 72a or 72b.

In the same way as in the outer fluid compression/supply device 34 configuring the sub-flow channel fluid compression/supply device as described above, the additional sub-flow channel fluid compression/supply device 44 compresses and pressurizes the fluid flowing in at least one of the corresponding sub-flow channels 82a and 82b, but preferably in each of both corresponding sub-flow channels 82a and 82b, and thereafter, supplies the pressurized fluid into the corresponding main flow channel 72a or 72b to accelerate the fluid flowing in the corresponding main flow channel 72a or 72b. As a result, it is possible to increase the rotation force transmitted to the common output shaft 30 from the two fluid receiving wheels 18a and 18b rotated by the fluid flowing in the main flow channels 72a and 82b.

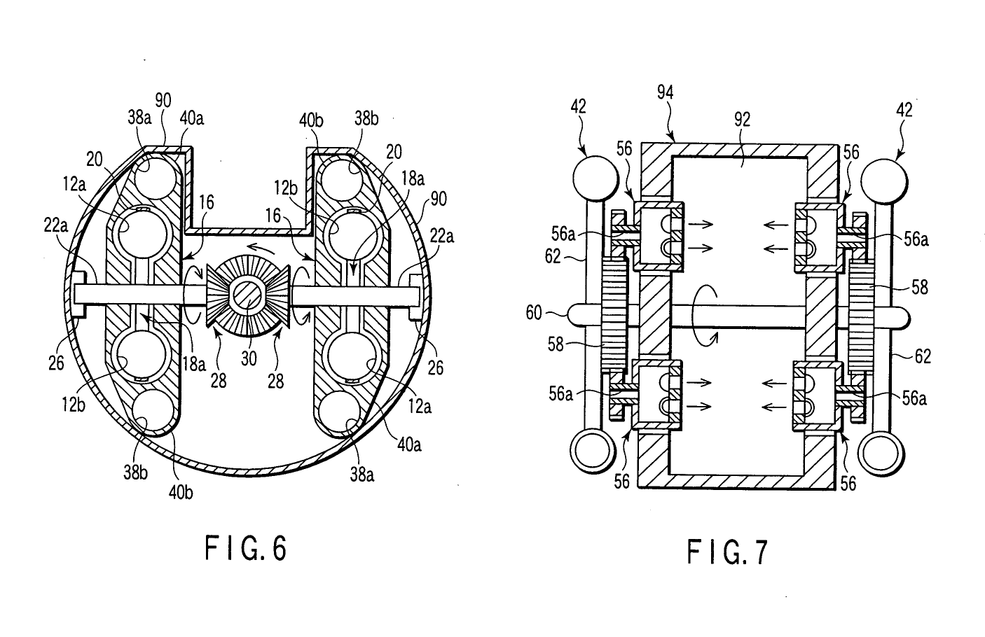

FIG. 6 schematically shows a vertical cross sectional view of a combination of two fluid force taking-up and boosting apparatuses 10, each according to the first embodiment shown in FIG. 1.

In this combination, the two fluid force taking-up and boosting apparatuses 10 shown in FIG. 1 are arranged in both sides of the common output shaft 30. The rotation direction of the rotation force transmitted to the common output shaft 30 from the two fluid receiving wheels 18a, 18b of the one fluid force taking-up and boosting apparatus 10 and the rotation direction of the rotation force transmitted to the common output shaft 30 from the two fluid receiving wheels 18a, 18b of the other fluid force taking-up and boosting apparatus 10 are so set that they make the common output shaft 30 rotate in a predetermined direction.

The two fluid force taking-up and boosting apparatuses 10 shown in FIG. 1 are surrounded by a common outer support housing 90.

Naturally, the two fluid force taking-up and boosting apparatuses 70 shown in FIG. 5 can be combined with each other in the same way.

FIG. 7 schematically shows a cross section of a device for compressing a fluid in a fluid flow channel.

In this device, two of the outer fluid compression/supply devices 42 shown in FIG. 4 are provided two portions opposed to each other in a circumferential wall of a fluid channel member 94, and the fluid channel member 94 has a fluid channel 92. The two outer fluid compression/supply devices 42 are connected to each other by the common rotation center shaft 60. Each outer fluid compression/supply device 42 includes the plurality of fluid compression mechanisms 56 arranged around the common rotation center shaft 60. When fluid receiving rotation members 62 of the two outer fluid compression/supply devices 42, together with the common rotation center shaft 60, are rotated in the same direction by a fluid flowing in an out side of the fluid channel member 94, the rotation force from the common rotation center shaft 60 is transmitted to the plurality of fluid compression mechanisms 56 of each of the outer fluid compression/supply devices 42 through the rotation force transmission mechanism 58. As a result, these fluid compression mechanisms 56 compress the outer fluid sucked through the fluid intake pipes 56a and then discharge the compressed fluid to the fluid channel 92 of the fluid channel member 94, so that the fluid in the fluid channel 92 is pressurized.

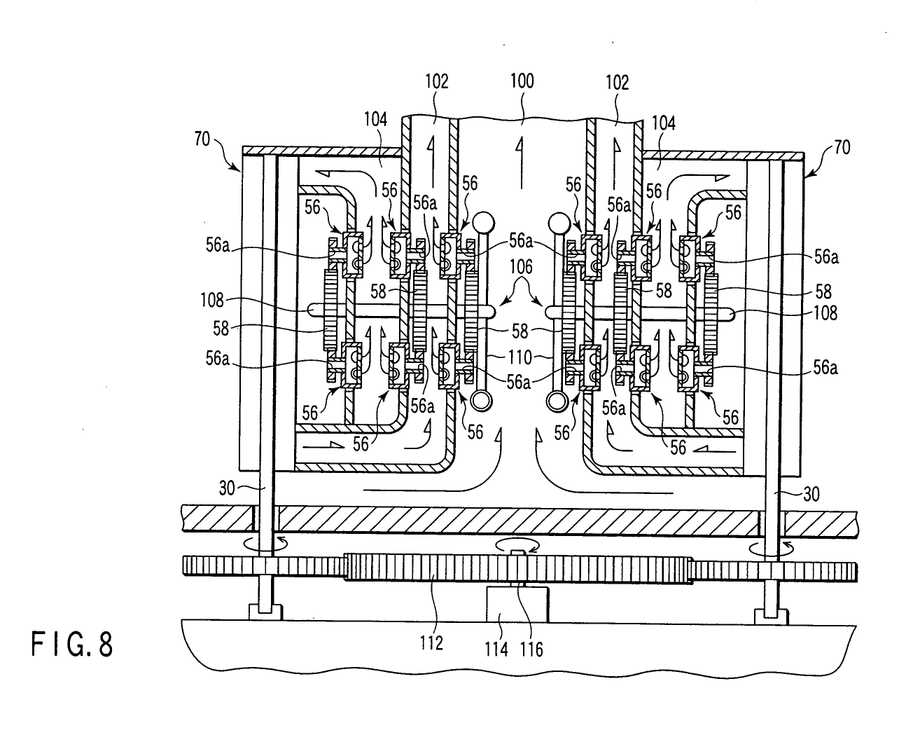

FIG. 8 schematically shows the fluid force taking-up and boosting apparatus 70 according to the second embodiment of this invention and combined with a flow channel along with a device for pressurizing a fluid in a fluid channel other than that of FIG. 7.

A first fluid flow channel member 102 co-axially surrounds a circumferential wall of a chimney 100, and a second fluid flow channel member 104 co-axially surrounds a circumferential wall of the first fluid flow channel member 102. A plurality of fluid force taking-up and boosting apparatuses 70 are arranged around the second fluid flow channel member 104. An upper end of the fluid flow channel of the second fluid flow channel member 104 connects the fluid inflow sides of the main flow channels 72a and 72b of the tubular member 76 and the fluid inflow sides of the sub-flow channels 82a and 82b of the sub-flow channel members 84a and 84b in each fluid force taking-up and boosting apparatus 70. The fluid outflow side of the main flow channel 72a of the tubular member 76 and the fluid outflow sides of the sub-flow channels 82a and 82b of the sub-flow channel members 84a and 84b in each fluid force taking-up and boosting apparatus 70 connect a lower end of the fluid flow channel of the first fluid flow channel member 102.

A plurality of outer fluid compression/supply devices 106 are provided on each of the circumferential walls of the chimney 100, first fluid flow channel member 102, and second fluid flow channel member 104, and the outer fluid compression/supply devices 106 on each of the circumferential walls of the chimney 100, first fluid flow channel member 102, and second fluid flow channel member 104 are arranged radially around the longitudinal center line of the chimney 100. The outer fluid compression/supply devices 106 include a plurality of rotation center shaft 108 arranged radially around the longitudinal center line of the chimney 100 and passing through the circumferential walls of the chimney 100, first fluid flow channel member 102, and second fluid flow channel member 104.

A fluid receiving rotation member 110 is fixed to the inner end portion of the rotation center shaft 108 projected in the flue of the chimney 100. A plurality of fluid compression mechanisms 56 are arranged on each of the circumferential walls of the chimney 100, first fluid flow channel member 102, and second fluid flow channel member 104 around the rotation center shaft 108. The rotation force of the rotation center shaft 108 is transmitted to the fluid compression mechanisms 56 arranged on each of the circumferential walls of the chimney 100, first fluid flow channel member 102, and second fluid flow channel member 104 around the rotation center shaft 108, through the well-known rotation force transmission mechanism 58, for example a spur gear train, arranged near to each of the circumferential walls of the chimney 100, first fluid flow channel member 102, and second fluid flow channel member 104.

When the fluid receiving rotation member 110 is rotated by a smoke rising in the flue of the chimney 100, this rotation is transmitted to the fluid compression mechanisms 56 arranged on each of the circumferential walls of the chimney 100, first fluid flow channel member 102, and second fluid flow channel member 104, through the rotation center shaft 108 and each rotation force transmission mechanism 58.

The entrance opening of the fluid suction pipe 56a of each fluid compression mechanism 56 arranged on the circumferential wall of the second fluid flow channel member 104 faces an outer space, and each fluid compression mechanism 56 sucks an outer fluid (the open air in this embodiment) in the outer space through the fluid suction pipe 56a, compresses the sucked fluid, and discharges the pressurized fluid into the fluid flow channel of the second fluid flow channel member 104 when the rotation force is transmitted to each fluid compression mechanism 56 as described above.

The entrance opening of the fluid suction pipe 56a of each fluid compression mechanism 56 arranged on the circumferential wall of the first fluid flow channel member 102 faces the fluid flow channel of the first fluid flow channel member 102, and each fluid compression mechanism 56 sucks a fluid flowing in the fluid flow channel of the first fluid flow channel member 102 through the fluid suction pipe 56a, compresses the sucked fluid, and discharges the pressurized fluid into the fluid flow channel of the second fluid flow channel 104 when the rotation force is transmitted to each fluid compression mechanism 56 as described above.

Further, the entrance opening of the fluid suction pipe 56a of each fluid compression mechanism 56 arranged on the circumferential wall of the chimney 100 faces the flue of the chimney 100, and each fluid compression mechanism 56 sucks a smoke flowing in the flue of the chimney 100 through the fluid suction pipe 56a, compresses the sucked smoke, and discharges the pressurized smoke into the fluid flow channel of the first fluid flow channel 102 when the rotation force is transmitted to each fluid compression mechanism 56 as described above.

The pressurized fluid discharged into the fluid flow channel of the second fluid flow channel member 104 from the fluid compression mechanisms 56 arranged on the circumferential wall of the second fluid flow channel member 104 and the fluid compression mechanisms 56 arranged on the circumferential wall of the first fluid flow channel member 102 flows in the fluid inflow sides of the main flow channels 72a and 72b of the tubular member 76 and the fluid inflow sides of the sub-flow channels 82a and 82b of the sub-flow channel members 84a and 84b in each fluid force taking-up and boosting apparatus 70. And, the pressurized fluid flown in each fluid force taking-up and boosting apparatus 70 rotates the two fluid receiving wheels 18a and 18b of each fluid force taking-up and boosting apparatus 70, and finally rotates the corresponding output shaft 30 in the predetermined direction.

One end portion of the output shaft 30 is connected to an input shaft 116 of an outer device 114 such as, for example an electric generator, through a well known rotation force transmission mechanism 112 such as, for example a spur gear train. Therefore, the rotation force from the output shaft 30 of each fluid force taking-up and boosting apparatus 70 is transmitted to the input shaft 116 of the outer device 114 by the well known rotation force transmission mechanism 112 and drives the outer device 114.

The fluid discharged out from the fluid outflow side of the main flow channel 72a of the tubular member 76 and the fluid outflow sides of the sub-flow channels 82a and 82b of the sub-flow channel members 84a and 84b in each fluid force taking-up and boosting apparatus 70 into the fluid flow channel of the first fluid flow channel member 102, is pressurized by the pressurized fluid discharged from the fluid compression mechanisms 56 arranged on the circumferential wall of the chimney 100 into the fluid flow channel of the first fluid flow channel member 102. A part of the fluid pressurized as described above in the fluid flow channel of the first fluid flow channel member 102 is discharged into the fluid flow channel of the second fluid flow channel member 104 through the fluid compression mechanisms 56 arranged on the circumferential wall of the first fluid flow channel member 102 and further increases the pressure of the fluid in the fluid flow channel of the second fluid flow channel member 104. As a result, the rotation force transmitted to the outer device 114 from each fluid force taking-up and boosting apparatus 70 driven by the pressurized fluid from the second fluid flow channel member 104, through each output shaft 30 and the rotation force transmission mechanism 112, is increased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fluid force taking-up and boosting apparatus comprising:
a tubular member which includes both end portions in a longitudinal direction, an inner space having through openings provided at the both end portions and communicated with an outer space through the openings, and a main bulkhead elongated in the inner space in the longitudinal direction and partitioning the inner space into two main flow channels elongating in the longitudinal direction, wherein one of the two main flow channels is configured to allow a flow of fluid from the one end portion toward the other end portion in the longitudinal direction, and the other of the two main flow channels is configured to allow a flow of fluid from the other end portion to the one end portion in the longitudinal direction;
two fluid receiving wheels which are supported rotatably at two positions spaced from one another in the longitudinal direction in the main bulkhead, and which rotate in the same direction by the fluids flowing in the two main flow channels at both sides of the main bulkhead;
a winding/interlocking member which is wound around the two fluid receiving wheels and interlocks the two fluid receiving wheels; and
an output shaft to which a rotation force from the two fluid receiving wheels is transmitted.

2. The apparatus according to claim 1, further comprising an outer fluid compression/supply device which is provided to correspond to at least one of the two main flow channels in the tubular member, and which is rotated by a fluid force of a fluid flowing in an outer side of the tubular member to compress the fluid flowing in the outer side and to supply the compressed outer fluid into the at least one corresponding main flow channel.

3. The apparatus according to claim 2, wherein the outer fluid compression/supply device is provided in a chimney and is rotated by a stream of smoke streaming in the chimney.

4. The apparatus according to claim 1, further comprising:
two sub-flow channel members which are provided to correspond to the two main flow channels at an outer circumferential surface of the tubular member and which include two sub-flow channels elongating along the two main flow channels, wherein each sub-flow channel member includes both end portions in a longitudinal direction, one sub-flow channel corresponding to the one main flow channel is configured to allow a flow of fluid from the one end portion to the other end portion in the longitudinal direction in the same way as the one main flow channel, and the other sub-flow channel corresponding to the other main flow channel is configured to allow a flow of fluid from the other end portion to the one end portion in the longitudinal direction in the same way as the other main flow channel; and
sub-flow channel fluid compression/supply devices which are respectively provided to the two sub-flow channels of the two sub-flow channel members, and which are rotated by fluid forces of the fluids flowing in the respective sub-flow channels to compress the fluids flowing in the respective sub-flow channels and to supply the compressed fluids into the corresponding main flow channels.

5. The apparatus according to claim 4, further comprising an outer fluid compression/supply device which is provided to correspond to at least one of the two sub-flow channel members, and which is rotated by a fluid force of a fluid flowing in an outer side of the at least one sub-flow channel member to compress the fluid flowing in the outer side of the at least one sub-flow channel member and to supply the compressed outer fluid into the sub-flow channel of the at least one corresponding sub-flow channel member.

6. The apparatus according to claim 5, wherein the outer fluid compression/supply device is provided in a chimney and is rotated by a stream of smoke streaming in the chimney.

7. The apparatus according to claim 5, wherein the outer fluid compression/supply device includes a sub-flow channel fluid compression/supply device which is provided in the sub-flow channel of the at least one corresponding sub-flow channel member, and which is rotated by the rotation force from the outer fluid compression/supply device to compress the fluid flowing in the at least one corresponding sub-flow channel and to supply the compressed fluid into the corresponding main flow channel.

8. The apparatus according to claim 7, wherein the outer fluid compression/supply device is provided in a chimney and is rotated by a stream of smoke streaming in the chimney.

9. A fluid force taking-up and boosting apparatus comprising:
a tubular member which includes both end portions in a longitudinal direction, an inner space having through openings provided at the both end portions and communicated with an outer space through the openings, and a main bulkhead elongated in the inner space in the longitudinal direction and partitioning the inner space into two main flow channels elongating in the longitudinal direction, wherein one of the two main flow channels is configured to allow a flow of fluid from the one end portion to the other end portion in the longitudinal direction, and the other of the two main flow channels is closed at the other end portion at least partially in the longitudinal direction by a baffle plate and is configured to allow a flow of fluid from the other end portion to the one end portion in the longitudinal direction;
two fluid receiving wheels which are supported rotatably at two positions spaced from one another in the longitudinal direction in the main bulkhead, and which rotate in the same direction by the fluids flowing in the two main flow channels at both sides of the main bulkhead;
a winding/interlocking member which is wound around the two fluid receiving wheels and interlocks the two fluid receiving wheels;
a communicating channel which is provided at a position closer to one end of the tubular member from the fluid receiving wheel close to the one end of the tubular member in the main bulkhead and allows a flow of fluid from the other main flow channel to the one main flow channel; and
an output shaft to which a rotation force from the two fluid receiving wheels is transmitted.

10. The apparatus according to claim 9, further comprising an outer fluid compression/supply device which is provided to correspond to at least one of the two main flow channels in the tubular member, and which is rotated by a fluid force of a fluid flowing in an outer side of the tubular member to compress the fluid flowing in the outer side and to supply the compressed outer fluid into the at least one corresponding main flow channel.

11. The apparatus according to claim 10, wherein the outer fluid compression/supply device is provided in a chimney and is rotated by a stream of smoke streaming in the chimney.

12. The apparatus according to claim 9, further comprising:
two sub-flow channel members which are provided to correspond to the two main flow channels at an outer circumferential surface of the tubular member and which include two sub-flow channels elongating along the two main flow channels, wherein each sub-flow channel member includes both end portions in a longitudinal direction, both sub-flow channels are configured to allow a flow of fluid from one end portion to the other end portion in the longitudinal direction in the same way as the two main flow channels; and
sub-flow channel fluid compression/supply devices which are respectively provided to the two sub-flow channels of the two sub-flow channel members, and which are rotated by fluid forces of the fluids flowing in the respective sub-flow channels to compress the fluids flowing in the respective sub-flow channels and to supply the compressed fluids into the corresponding main flow channels.

13. The apparatus according to claim 12, further comprising an outer fluid compression/supply device which is provided to correspond to at least one of the two sub-flow channel members, and which is rotated by a fluid force of a fluid flowing in an outer side of the at least one sub-flow channel member to compress the fluid flowing in the outer side of the at least one sub-flow channel member and to supply the compressed outer fluid into the sub-flow channel of the at least one corresponding sub-flow channel member.

14. The apparatus according to claim 13, wherein the outer fluid compression/supply device is provided in a chimney and is rotated by a stream of smoke streaming in the chimney.

15. The apparatus according to claim 13, wherein the outer fluid compression/supply device includes a sub-flow channel fluid compression/supply device which is provided in the sub-flow channel of the at least one corresponding sub-flow channel member, and which is rotated by the rotation force from the outer fluid compression/supply device to compress the fluid flowing in the at least one corresponding sub-flow channel and to supply the compressed fluid into the corresponding main flow channel.

16. The apparatus according to claim 15, wherein the outer fluid compression/supply device is provided in a chimney and is rotated by a stream of smoke streaming in the chimney.
